(19) United States
(12) Patent Application Publication
(10) Pub. No.: US 2024/0316509 A1
(43) Pub. Date: Sep. 26, 2024

(54) Receiving Device For Receiving a Gas Cartridge for a Carbonation Machine; Carbonation Machine; Method for Using a Carbonation Machine

(71) Applicant: SODAPOP GmbH, Bergisch Gladbach (DE)

(72) Inventors: Stefan Stalder, Zollikofen (CH); Günter Empl, Bergisch Gladbach (DE)

(21) Appl. No.: 18/578,055

(22) PCT Filed: Jul. 14, 2022
(86) PCT No.: PCT/EP2022/069785

§ 371 Date: Jan. 10, 2024

(30) Foreign Application Priority Data
Jul. 15, 2021 (DE) 10 2021 207 554.1

(51) Int. Cl. B01F 23/236; B01F 23/2361; B01F 23/237; B01F 33/501; B01F 101/14

(52) U.S. Cl. CPC B01F 23/2364; B01F 23/2361; B01F 23/237621; B01F 33/5014; B01F 2101/14

(57) ABSTRACT

A receiving apparatus for receiving a gas cartridge for a carbonation machine, the receiving apparatus includes a pressure chamber in which an overpressure is generated; with aid of the overpressure generated in the pressure chamber: i) a seal means is configured to be pressed onto the gas cartridge; and/or ii) the gas cartridge is configured to be fastened to the carbonation machine; the receiving apparatus includes: a pressure transmission means to press the seal means onto the gas cartridge by way of the overpressure generated in the pressure chamber during a carbonation operation; and a spring device configured to exert a force on the pressure transmission means.

### CROSS REFERENCE TO RELATED APPLICATIONS

This application is a US National Stage of PCT/EP2022/069785 filed on Jul. 14, 2022, which claims priority to DE 10 2021 207 554.1 filed on Jul. 15, 2021, all of which are hereby incorporated by reference herein for all purposes.

### FIELD

The present invention is based on a receiving apparatus for receiving a gas cartridge for a carbonation machine. The present invention also relates to a carbonation machine and to a method for using a carbonation machine.

### BACKGROUND

Carbonation machines, which are intended to carbonate a liquid, for example water, are generally known. Such carbonation machines are in particular also referred to as drinking water soda machines and are used, among other things, as household appliances by end consumers. The carbonation machines can in principle be used to carbonate different liquids and to prepare different beverages. For the carbonation, the machines typically comprise an exchangeable gas cartridge, in particular a CO₂ cartridge, which provides the gas with which the liquid is mixed. The liquid to be carbonated is typically filled into a bottle. The bottle with the liquid to be carbonated is then fitted to the carbonation machine in order to carry out the carbonation.

The safe and user-convenient fitting and fastening of the gas cartridge in the carbonation machine is an important aspect in the application. During the carbonation, a high pressure is produced, which makes fail-safe fitting of the gas cartridge to the carbonation machine necessary. On the other hand, the gas cartridges should be able to be changed in an uncomplicated manner for the user, such that an empty gas cartridge can be removed from the carbonation machine and replaced by a full gas cartridge without any problems.

### BACKGROUND

It is an object of the present invention to provide a receiving apparatus for receiving a gas cartridge for a carbonation machine, said receiving apparatus enabling user-friendly and at the same time secure and stable fastening of a gas cartridge to the carbonation machine, wherein preferably a high flexibility with respect to the use of different gas cartridges is enabled. It is also an object to provide a corresponding carbonation machine.

This object is achieved by a receiving apparatus as claimed in claim 1. The receiving apparatus according to the invention for receiving a gas cartridge on a carbonation machine has the advantage over the prior art that, with the aid of the pressure chamber, secure and stable fastening and sealing (toward the outside) for a gas cartridge on a carbonation machine can be achieved with the aid of pneumatic compensation. According to the invention, it is particularly advantageous that, with the aid of the receiving apparatus, different gas cartridges, in particular with different heights and tolerances, can be securely fastened to the carbonation machine and can be sealed toward the outside during the carbonation. With the aid of the receiving apparatus according to the invention, it is also advantageously possible for gas cartridges with differently formed mouth regions and/or valves to be securely fitted to the carbonation machine, fastened and sealed toward the outside during the carbonation. It is a particular advantage that no thread is required for fitting and fastening the gas cartridge to the carbonation machine. It is thus possible to use gas cartridges without a thread, but also gas cartridges with a thread, wherein it is advantageously not necessary to use the thread thereof when fitting the gas cartridge to the carbonation machine. According to the invention, it is thus possible for gas cartridges with different diameters at the mouth region or with differently embodied threads (or entirely without a thread) to be fitted to the carbonation machine. It is a further advantage of the present invention that the receiving apparatus and thus also the carbonation machine can be used particularly flexibly with different gas cartridges having different gas cartridge heights, even if the gas cartridges have comparatively large height differences and/or manufacturing tolerances. According to the invention, a fastening of the gas cartridge to the receiving apparatus can be achieved, said fastening also safely withstanding the high pressure during the carbonation. At the same time, it is possible to achieve particularly high user convenience, since the fastening of the gas cartridge to the carbonation machine and the removal of the gas cartridge from the carbonation machine can be performed conveniently, in particular without any screwing of the gas cartridge, for the user. Furthermore, no motorization or similar is required for the fixing and secure fastening of the gas cartridge, as a result of which the susceptibility to errors and the costs can be reduced.

According to the invention, it is conceivable for the gas cartridge to be arranged perpendicularly in the carbonation machine. In particular, a central axis of the gas cartridge is arranged perpendicularly with respect to the underlying surface, for example a worktop or a tabletop. Alternatively, an angled arrangement of the gas cartridge (at an angle different from 90° with respect to the underlying surface) is also conceivable.

With the aid of the receiving apparatus according to the invention for receiving a gas cartridge for a carbonation machine, the gas cartridge is in particular able to be reversibly connected to the carbonation machine. The gas cartridge can thus preferably be detached from the carbonation machine, for example when the gas cartridge is empty.

The gas cartridge is in particular able to be inserted and/or introduced into the carbonation machine by a user with the aid of the receiving apparatus. According to the present invention, it is possible that, when the gas cartridge is being received or inserted, no (final) securing/fastening of the gas cartridge to the carbonation machine or to the receiving apparatus is effected. It is thus particularly advantageously possible for the gas cartridge to not need to be fastened separately by the user when the gas cartridge is being received. It is thus for example possible to dispense with screwing of the gas cartridge in the carbonation machine when introducing the gas cartridge. The fastening and in particular the securing of the gas cartridge to the carbonation machine is preferably effected in an automated manner with the aid of the pressure chamber by way of pneumatic compensation during the carbonation, which increases user convenience and facilitates operability. However, it is also conceivable according to the invention for there to be additional fastening mechanisms or securing means for the gas cartridge.

It is preferably conceivable according to the invention for the carbonation machine and the receiving apparatus for receiving the gas cartridge on a carbonation machine to be intended for domestic use.

According to the invention, an overpressure can in particular be understood to mean a pressure lying above an ambient pressure and/or an air pressure of the atmosphere, in particular a pressure above 1 bar. According to the invention, it is possible for the overpressure generated in the pressure chamber to lie further above the atmospheric pressure during the carbonation.

According to one embodiment of the present invention, it is conceivable for the carbonation machine to comprise a further receiving apparatus for receiving the bottle, in particular the bottle filled with liquid, said receiving apparatus being able to be used to receive the bottle on the carbonation machine and in particular to securely fasten it thereto.

With the aid of the further receiving apparatus, the bottle is in particular able to be reversibly connected to the carbonation machine. The bottle can thus preferably be detached from the carbonation machine, in particular after the carbonation of the liquid in the bottle has been carried out and/or has ended.

The liquid to be carbonated in the bottle may, for example, be water or a flavoring-containing beverage. The bottle, in particular the bottle filled with the liquid, can have different shapes and also be understood to be a cartridge or vessel.

The bottle preferably comprises glass. It is conceivable for the bottle to be completely or partially manufactured from glass. Alternatively or additionally, it is conceivable for the bottle to comprise plastic and/or metal.

The bottle is preferably filled with the liquid to be carbonated and said liquid is particularly preferably already present in the bottle when the bottle is received in the further receiving apparatus.

The bottle is preferably configured in such a way that it withstands an internal pressure that is increased in comparison with the normal ambient pressure (of about 1 bar). By way of example, it is conceivable for the bottle to be configured in such a way that it withstands an internal pressure of up to 11 bar, preferably up to 15 bar, without bursting (at a temperature of 20° C. and an external pressure of 1 bar).

The gas cartridge is preferably configured in such a way that it withstands an internal pressure that is increased in comparison with the normal ambient pressure (of about 1 bar).

The gas cartridge is in particular a cartridge filled with CO₂ which provides the gas, thus in particular the CO₂, for carbonation of the liquid. The gas cartridge can also be understood to be a gas cylinder.

Advantageous refinements and developments of the invention can be gathered from the dependent claims and from the description with reference to the drawings.

According to a preferred embodiment of the present invention, provision is made for the receiving apparatus to be configured in such a way that, during a carbonation operation, the pressure chamber is connected to an interior space of the gas cartridge in such a way that the overpressure is generated in the pressure chamber, in particular during the carbonation. It is advantageously possible for the overpressure to be generated, in particular during the carbonation of a liquid in a bottle fitted to the carbonation machine, in the pressure chamber with the aid of the gas cartridge, in particular by virtue of the gas passing from the gas cartridge into the pressure chamber.

According to a preferred embodiment of the present invention, provision is made for the receiving apparatus to be configured in such a way that, in particular during the carbonation, with the aid of the overpressure generated in the pressure chamber:
the seal means is pressed onto the gas cartridge, in particular onto a mouth region of the gas cartridge, and/or
the gas cartridge is fastened to, in particular clamped on, the carbonation machine. In this case, it is particularly advantageously possible for the gas cartridge to be clamped over its entire length, in particular at the top and bottom, and thus to be advantageously and securely fastened, by the force formed with the aid of the overpressure in the pressure chamber. In particular, it is advantageously possible according to one embodiment of the present invention for the gas cartridge, in contrast to systems known from the prior art, to not only be fastened by its thread or via the region of its thread in the carbonation machine but also to be clamped on its upper side and its lower side.

According to a preferred embodiment of the present invention, provision is made for the pressure chamber to be a part of a gas connection through which gas from the interior space of the gas cartridge is able to be introduced, in particular during the carbonation, into a bottle which is in particular filled with a liquid. The pressure chamber is thus preferably part of the gas connection between the gas cartridge and the bottle filled with the liquid to be carbonated. In this way, the pressure in the pressure chamber is advantageously automatically generated at the start of the carbonation. If the gas cartridge is opened during the carbonation, an overpressure is produced in the gas connection between the gas cartridge and the bottle and thus also in the pressure chamber. This overpressure in the pressure chamber preferably has the effect that the seal means is pressed against the gas cartridge, preferably against the mouth region of the gas cartridge, which advantageously results in sealing of the gas cartridge and of the gas connection in relation to the environment. This makes it possible to achieve a particularly secure, space-saving and efficient arrangement.

According to a preferred embodiment of the present invention, provision is made for the receiving apparatus to comprise a pressure transmission means. According to one embodiment of the present invention, the pressure transmission means can also be understood to be a pneumatic compensator. The pressure transmission means may, for example, be a plastics component. Alternatively or additionally, the pressure transmission means can also comprise other materials, such as metal.

According to a preferred embodiment of the present invention, provision is made for the receiving apparatus to be configured in such a way that, during the carbonation, the pressure transmission means presses the seal means onto the gas cartridge by way of the overpressure generated in the pressure chamber. The pressure transmission means is in particular arranged in such a way that it is pressed in the direction of the gas cartridge by the overpressure generated in the pressure chamber and in so doing the seal means presses against the gas cartridge. With the aid of the pressure transmission means, it is thus also possible for an advantageous fastening of the gas cartridge to be achieved during the carbonation.

According to a preferred embodiment of the present invention, provision is made for the pressure transmission means to be movable, wherein the pressure transmission means forms a part of a boundary and/or wall of the pressure chamber. In this way, it is possible for the pressure transmission means to be pressed and/or moved in the direction of the gas cartridge when an overpressure is built up in the pressure chamber and depending on this overpressure. Due to the fact that the pressure transmission means forms a part of the boundary and/or wall of the pressure chamber, it is possible for the size of the pressure chamber to be able to change, in particular increase, during the formation of an overpressure in the pressure chamber, since the pressure transmission means is moved by the overpressure built up in the pressure chamber. The pressure transmission means is in particular movable within the carbonation machine in a perpendicular direction, that is to say in particular parallel to the central axis of the gas cartridge.

According to a preferred embodiment of the present invention, provision is made for the seal means to be partially or completely arranged between the pressure transmission means and the gas cartridge, in particular between the pressure transmission means and a mouth region of the gas cartridge. In this way, it is advantageously possible for the seal means to be pressed onto the gas cartridge by the pressure transmission means. It is thus advantageously possible for the gas connection between the interior space of the gas cartridge and the bottle to be sealed toward the outside during the carbonation. In this case, a high quality seal can be achieved, which also withstands the high pressure in the gas connection during the carbonation.

According to a preferred embodiment of the present invention, provision is made for the seal means to comprise a sealing ring, in particular an O-ring. Suitable as sealing ring is also a flat sealing disk with a passage opening, in particular a central passage opening or a passage opening offset from the center. Alternatively or additionally, it is conceivable for the seal means to be formed in one piece with the pressure transmission means, for example as a sealing region of the pressure transmission means.

According to a preferred embodiment of the present invention, provision is made for the receiving apparatus to be configured in such a way that, in particular during the carbonation, the gas cartridge is clamped with the aid of the pressure transmission means and/or fastened in the receiving apparatus. In particular, with the aid of the pressure transmission means which is pressed in the direction of the gas cartridge by the overpressure in the pressure chamber, the gas cartridge is clamped and securely fastened in the carbonation machine.

According to one embodiment of the present invention, it is conceivable for the receiving apparatus to be configured in such a way that, in particular during the carbonation, the gas cartridge is clamped between the seal means and/or the pressure transmission means on its upper side and a counterpart element, in particular a bottom region of the carbonation machine, on its lower side. In this way, advantageous clamping of the gas cartridge over its entire height becomes possible.

According to a preferred embodiment of the present invention, it is conceivable for the receiving apparatus to comprise a guide element, wherein the pressure transmission means is arranged within a cutout in the guide element, wherein the pressure transmission means is preferably movable within the cutout in the guide element, in particular parallel to a central axis of the gas cartridge when the latter is arranged in the receiving apparatus.

According to a preferred embodiment of the present invention, provision is made for a further seal means to be arranged between an inner wall of the guide element and the pressure transmission means. The inner wall of the guide element is in particular a wall forming the cutout in the guide element.

According to a preferred embodiment of the present invention, provision is made for the further seal means to comprise a sealing ring. Alternatively or additionally, it is conceivable for the further seal means to be formed in one piece with the pressure transmission means or the guide element, for example as a sealing region of the pressure transmission means or of the guide element.

According to one embodiment of the present invention, provision is made for the receiving apparatus to comprise a spring device, wherein a force is able to be exerted on the pressure transmission means in particular with the aid of the spring device. When introducing the gas cartridge into the receiving apparatus, the gas cartridge is moved from below against the pressure transmission means and pushes the latter upward. The movement of the pressure transmission means upward has the effect that the spring device is compressed. The spring device is thus compressed and, as a result, preloaded when the gas cartridge is being introduced. In this way, even in the starting state or the starting position, that is to say after the gas cartridge has been introduced into the receiving apparatus but for example before the carbonation is commenced, a force/a pressure is exerted on the pressure transmission means with the aid of the preloaded spring device, as a result of which the pressure transmission means is pressed downward in the direction of the gas cartridge. It is thus possible for the seal means to be pressed onto the mouth region of the gas cartridge by the pressure transmission means even in the starting state, prior to a carbonation operation. However, this pressure produced by the spring device or this force is preferably considerably lower than the force which is exerted with the aid of the pressure chamber during the carbonation and which presses the sealing element onto the gas cartridge. It is conceivable for the spring device to form a resistance when the gas cartridge is being introduced into the receiving apparatus and to be preloaded when the gas cartridge is being introduced. The spring device in particular ensures that the pressure transmission means in the starting position is guided in the direction of the gas cartridge, such that the gas cartridge is preferably positioned without play in the carbonation machine. The spring device makes it possible for gas cartridges with different extents along their central axis, that is to say with different heights, to be arranged particularly advantageously in the carbonation machine and in particular to be positioned without play. This makes it possible to achieve an advantageous compatibility with different gas cartridges and also a particularly advantageous compensation of tolerances of the gas cartridges. At the same time, the introducing of the gas cartridge and the positioning of the gas cartridge is very convenient for the user, since merely a relative movement between the gas cartridge and the receiving apparatus, in particular at least partially parallel to the central axis of the gas cartridge, is necessary in order to introduce and position the gas cartridge in the carbonation machine and in particular to preload the spring device. In this case, the relative movement between the gas cartridge and the receiving apparatus when the gas cartridge is being introduced can be effected both by virtue of the gas cartridge being moved into the receiving apparatus from below and by virtue of the receiving apparatus being guided onto the gas cartridge from above. It is conceivable for the gas cartridge to be able to be introduced into the receiving apparatus by a pivoting movement or tilting movement.

The spring device in particular comprises a spring which is arranged so as to run in encircling fashion or to run partially in encircling fashion around the rod-like element. The spring is preferably arranged between the guide element and the pressure transmission means. It is in particular conceivable for the spring to be in the form of a helical spring, for example in the form of a cylindrical, conical or barrel-like helical spring. When the gas cartridge is being introduced into the receiving apparatus, the gas cartridge is moved relative to the pressure transmission means, in particular in the direction of the pressure transmission means, and thus pushes the pressure transmission means in particular in the direction of the spring. The spring is compressed and preloaded as a result.

A further subject of the present invention is a carbonation machine, comprising a receiving apparatus for receiving a gas cartridge according to one embodiment of the present invention.

According to one embodiment of the present invention, provision is made for a gas feed means to project into the bottle during the carbonation. The gas feed means is a part of the gas connection formed between the interior space of the gas cartridge and the bottle (or the interior space of the bottle) during the carbonation, such that the gas in the gas cartridge is introduced into the bottle via the gas feed means during the carbonation.

According to one embodiment of the present invention, provision is made for the carbonation machine to comprise an actuating device for commencing and/or carrying out a carbonation operation, in particular by a user.

According to one embodiment of the present invention, provision is made for the actuating device to comprise an opening means for opening the gas cartridge.

According to one embodiment of the present invention, provision is made for the seal means to comprise a passage opening through which the opening means passes. By way of example, the seal means may be embodied as a sealing ring with a central passage opening or with a passage opening offset from the center.

According to one embodiment of the present invention, provision is made for the opening means to be able to be transferred from a starting position to a carbonation position, wherein the opening means is arranged in the carbonation position during the carbonation. In particular, for commencing the carbonation, the opening means is transferred from its starting position to its carbonation position with the aid of the actuating device.

According to one embodiment of the present invention, provision is made for the opening means in the carbonation position to open a closure means of the gas cartridge, in particular in such a way that gas can escape from the interior space of the gas cartridge and/or the gas connection between the interior space of the gas cartridge and the bottle is formed. The closure means seals the interior space of the gas cartridge in a starting state of the gas cartridge, such that gas can be kept available at high pressure in the gas cartridge. To carry out the carbonation, the closure means is opened with the aid of the opening means, such that gas can pass from the gas cartridge via the gas connection into the bottle filled with the liquid to be carbonated. It is in particular conceivable for the closure means to close the gas cartridge again after the carbonation. The closure means in particular comprises a valve which can be opened with the aid of the opening means.

According to one embodiment of the present invention, provision is made for the opening means to comprise a rod-like element or be in the form of a rod-like element. It is conceivable for the rod-like element to be guided downward, in particular parallel to the central axis of the gas cartridge, when the carbonation is commenced and in so doing to open the closure means of the gas cartridge in order to carry out the carbonation. It is possible for a gas channel to be formed adjoining the rod-like element and/or as part of the rod-like element, said gas channel connecting the interior space of the gas cartridge to the pressure chamber during the carbonation. The gas channel can have different shapes or cross sections. It is possible for the gas channel to be partially or completely formed between the rod-like element and the pressure transmission means. It is preferably possible for the gas channel to be a part of the gas connection formed between the interior space of the gas cartridge and the bottle during the carbonation.

According to one embodiment of the present invention, provision is made for the actuating device to comprise an actuating means, in particular a lever device and/or a pushbutton, wherein the opening means is able to be transferred from its starting position to the carbonation position in particular upon actuation of the actuating means by a user. Here, it is also possible for the actuating means to comprise both a lever device and a pushbutton, wherein the pushbutton is connected to the lever device or has a mechanical contact with respect to the lever device. It is conceivable for the lever device to thus be able to be actuated by the user via the pushbutton. Different designs are suitable for the lever device and/or the pushbutton.

According to one embodiment of the present invention, provision is made for a position of the opening means in its starting position to be configured depending on a height of the gas cartridge, in particular in such a way that the opening means rests on the gas cartridge or on an element connected to the gas cartridge, in particular the closure means. As a result of its own dead weight and gravity, the opening means is in particular arranged in such a way that in its starting position it rests on the gas cartridge or on an element connected to the gas cartridge. Alternatively or additionally, it is conceivable for the opening means to be arranged with the aid of the spring device and the pressure transmission means in such a way that in its starting position it rests on the gas cartridge or on the element connected to the gas cartridge.

According to one embodiment of the present invention, provision is made for the opening means to be carried along by the force acting on the pressure transmission means with the aid of the spring device and thus to already be guided in the direction of the gas cartridge in the starting position. It is in particular conceivable for the opening means to comprise a carrying-along means, wherein the pressure transmission means carries along the opening means by way of the carrying-along means, in particular by way of the force acting on the pressure transmission means with the aid of the spring device in the direction of the gas cartridge. It is conceivable for the carrying-along means to comprise a projection which runs partially or completely in encircling fashion around the rod-like element in a circumferential direction, wherein the projection can engage into the pressure transmission means, such that the rod-like element is carried along in the direction of the gas cartridge and is already positioned close to the gas cartridge in the starting position. In particular, with the aid of the carrying-along means, a movement of the opening means upward is limited in the starting position. Other designs for the carrying-along means are also suitable. It is alternatively or additionally conceivable for the pressure transmission means to comprise a carrying-along means for guiding and/or positioning the opening means in the starting position.

According to one embodiment of the present invention, provision is made for a height compensation means to be able to be arranged between the opening means and the actuating means. With the aid of the height compensation means, it is advantageously possible for gas cartridges of different height to be able to be used in the carbonation machine, wherein the actuating means is already automatically arranged in the starting position for each of these gas cartridges with different heights such that the opening means can be moved by the actuating means. With the aid of the height compensation means, it is thus possible for the contact point or actuating point for the user to remain the same even for different gas cartridges with different heights. The height compensation means is advantageously configured in such a way that a pushbutton and/or a lever device triggers at the same actuating point for different gas cartridges.

According to one embodiment of the present invention, provision is made for the height compensation means to comprise a wedge-like element. It is thus in particular conceivable for a wedge-like element to be able to be arranged between the opening means and the actuating means. It is preferably possible for the wedge-like element to be able to be arranged between the opening means and the lever device. With the aid of the wedge-like element, advantageous height compensation can be effected in the receiving apparatus and/or actuating apparatus for different gas cartridges (with in particular different heights). It is thus possible for the carbonation machine to be used particularly flexibly with different gas cartridges, even if the gas cartridges have comparatively large height differences and/or manufacturing tolerances.

According to one embodiment of the present invention, it is conceivable for the wedge-like element to taper in one direction. Different designs and geometries are suitable for the exact profile of the tapering here.

According to one embodiment of the present invention, provision is made for the opening means to be connected to the wedge-like element, wherein the opening means in its starting position carries along the wedge-like element in such a way that an insertion depth of the wedge-like element between the opening means and the actuating means is dependent on the position of the opening means in its starting position. The position of the opening means in the starting position is in particular dependent on the height of the gas cartridge introduced. The starting position in particular refers to a position in which the gas cartridge has already been introduced into the receiving apparatus but the carbonation has not yet been commenced. The wedge-like element thus makes it possible to ensure that mechanical contact between the opening means and the actuating means, for example the lever device, is formed in each case in the starting position, even for different gas cartridge heights, since the insertion depth of the wedge-like element between the opening means and the actuating means is dependent on the position of the opening means in the starting position. It is thus advantageously possible for the wedge-like element to be updated, in particular depending on the height or extent of the gas cartridge introduced into the carbonation machine, such that the actuating means is already arranged in the starting position such that it engages directly upon actuation by a user and in particular does not need to first be guided by the user until mechanical contact is formed, as a result of which the actuating means can move the opening means. It is thus possible for the actuating means to in each case already automatically be arranged in the starting position for gas cartridges with different heights such that the opening means can be moved by the actuating means. If, for example, a comparatively small gas cartridge with a low height is used, it is thus possible with the aid of the wedge-like element to prevent a user from having to press down the actuating means, for example a pushbutton and/or a lever device, very far before the carbonation is commenced. In this way, the contact point or actuating point remains the same for the user for different gas cartridges with different heights. By way of example, a pushbutton and/or a lever device triggers at the same actuating point for different gas cartridges.

With the aid of the wedge-like element, it is thus possible to achieve height compensation for different gas cartridge heights. In particular, it is conceivable for height differences of up to 7 mm, preferably up to 15 mm, to be able to be compensated with the aid of the wedge-like element.

According to one embodiment of the present invention, provision is made for the wedge-like element to be moved between the opening means and the actuating means when the gas cartridge is being introduced into the receiving apparatus. The insertion depth of the wedge-like element between the opening means and the actuating means is dependent in this case in particular on the height of the gas cartridge introduced.

According to one embodiment of the present invention, provision is made for the opening means to be connected to the wedge-like element with the aid of a lever system. In this case, the wedge-like element may be an element which is separate from the lever system and which is connected to the lever system, or be a part of the lever system. By way of the lever system, the wedge-like element is carried along by the opening means, such that the position of the wedge-like element in the starting position is dependent on the position of the opening means in the starting position.

According to one embodiment of the present invention, provision is made for the lever system to be configured in such a way that an axial movement of the opening means, in particular parallel to a central axis of the gas cartridge, is converted into a lateral movement of the wedge-like element, in particular perpendicularly with respect to the central axis of the gas cartridge, with the aid of the lever system.

A further subject of the present invention is a method for using a carbonation machine according to one embodiment of the present invention,
wherein a bottle filled with a liquid is fitted to the carbonation machine,
wherein carbonation of the liquid is carried out with the aid of the carbonation machine,
wherein, when carrying out the carbonation, an overpressure is generated in the pressure chamber of the receiving apparatus,
wherein, with the aid of the overpressure generated in the pressure chamber,
   a seal means is pressed onto the gas cartridge and/or
   the gas cartridge is fastened to the carbonation machine.

According to one embodiment of the present invention, in particular of the method, it is possible for the bottle with the carbonated liquid to be able to be separated from the carbonation machine and in particular removed from the carbonation machine after the carbonation has been carried out.

According to one embodiment of the present invention, in particular of the method, it is possible for the gas cartridge to be arranged on the carbonation machine and in particular positioned in the carbonation machine with the aid of the receiving apparatus prior to the carbonation being carried out. It is also conceivable for the gas cartridge to be removed from the carbonation machine and replaced by a further filled gas cartridge after the carbonation (or one or more further carbonation operations) has been carried out and/or once the gas cartridge is empty.

It is preferably possible for the carbonation to be effected with the aid of the gas cartridge, wherein a gas connection between the interior space of the gas cartridge and the bottle with the liquid to be carbonated is formed during the carbonation. In this case, a gas feed means preferably projects into the bottle during the carbonation. The gas feed means is a part of the gas connection formed between the interior space of the gas cartridge and the bottle (or the interior of the bottle) during the carbonation. During the carbonation, the gas in the gas cartridge is introduced into the bottle with the aid of the gas feed means for carbonation of the liquid.

According to one embodiment of the present invention, the pressure chamber, in which the overpressure is generated during the carbonation, is also a part of the gas connection between the interior space of the gas cartridge and the bottle. The overpressure in the pressure chamber is thus automatically generated by the overpressure in the gas cartridge during the carbonation, as a result of which particularly advantageous and automatic pneumatic compensation is obtained.

The advantages and refinements which have already been described in connection with the receiving apparatus according to the invention for receiving a gas cartridge for a carbonation machine or in connection with an embodiment of the receiving apparatus according to the invention can apply to the carbonation machine according to the invention and to the method according to the invention for using a carbonation machine. The advantages and refinements which have already been described in connection with the carbonation machine according to the invention or in connection with an embodiment of the carbonation machine according to the invention can apply to the receiving apparatus according to the invention for receiving a gas cartridge for a carbonation machine and to the method according to the invention for using a carbonation machine. The advantages and refinements which have already been described in connection with the method according to the invention for using a carbonation machine or in connection with an embodiment of the method according to the invention for using a carbonation machine can apply to the receiving apparatus according to the invention for receiving a gas cartridge for a carbonation machine and to the carbonation machine according to the invention.

Further details, features and advantages of the invention will emerge from the drawings and from the following description of preferred embodiments on the basis of the drawings. Here, the drawings illustrate merely exemplary embodiments of the invention, which do not restrict the essential concept of the invention.

### BRIEF DESCRIPTION OF THE DRAWINGS

FIG. 1 shows a schematic illustration of a receiving apparatus for receiving a gas cartridge according to one exemplary embodiment of the present invention.

FIG. 2 shows a schematic illustration of a carbonation machine according to one exemplary embodiment of the present invention.

FIG. 3 shows a schematic illustration of a part of a receiving apparatus for receiving a gas cartridge according to one exemplary embodiment of the present invention.

FIG. 4 shows a schematic illustration of a part of a receiving apparatus for receiving a gas cartridge according to one exemplary embodiment of the present invention.

FIG. 5 shows a schematic illustration of a part of a receiving apparatus for receiving a gas cartridge according to one exemplary embodiment of the present invention.

### DETAILED DESCRIPTION

Identical parts are always denoted by the same reference designations in the various figures, and will therefore generally also each be designated or mentioned only once.

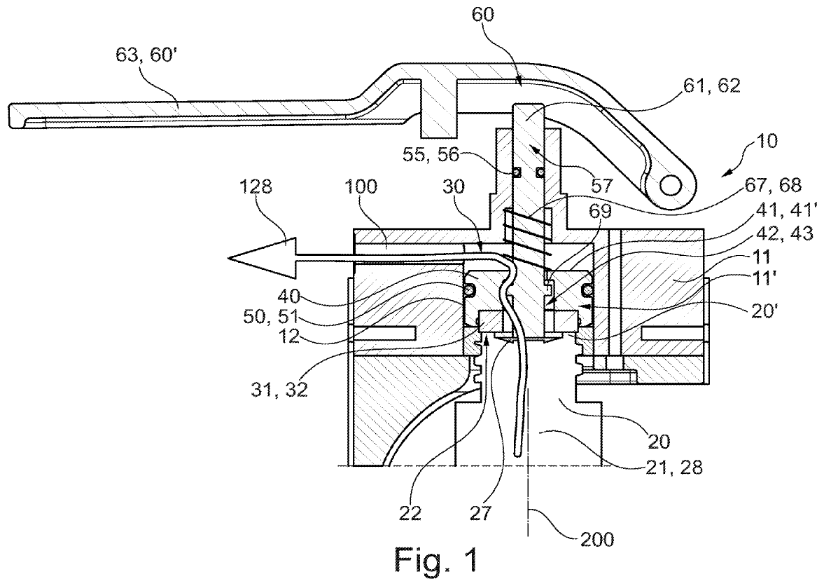

FIG. 1 shows a schematic illustration of a receiving apparatus 10 for receiving a gas cartridge 20 according to one exemplary embodiment of the present invention. The receiving apparatus 10 is part of a carbonation machine 1 or able to be connected to a carbonation machine 1. In the illustration shown, a gas cartridge 20 is received with the aid of the receiving apparatus 10. The gas cartridge 20 is a pressure-stable cartridge, in the interior space 21 of which a gas 28, in particular CO₂, is contained at high pressure. The gas cartridge 20 provides the gas 28 for carbonation of a liquid 4 located in an interior space 3 of a bottle 2.

The receiving apparatus 10 is configured in such a way that the gas cartridge 20 can be fastened to the carbonation machine 1 via the receiving apparatus 10. The receiving apparatus 10 comprises a guide element 11 with a cutout 11′. A pressure transmission means 40 is arranged in the cutout 11′. Both the guide element 11 and the pressure transmission means 40 can each be one-part or multi-part components. The receiving apparatus 10 further comprises a spring device 67, in particular comprising a helical spring 68. The spring device 67 is arranged between the pressure transmission means 40 and a horizontal region of the guide element 11. When the gas cartridge 20 is being introduced into the receiving apparatus 10, the gas cartridge 20 can be guided from below by a user into that part of the receiving apparatus 10 which is shown in FIG. 1. Alternatively, it is possible for the receiving apparatus 10 to be moved onto the gas cartridge 20 from above. A tilting movement/pivoting movement of the gas cartridge 20 is also conceivable. When the gas cartridge 20 is being introduced, the gas cartridge 20 is moved relative to the pressure transmission means 40 and pushes the latter upward, such that the spring device 67 is compressed and preloaded. In this case, with the aid of the spring device 67, gas cartridges 20 with different heights can be received by the receiving apparatus 10, and advantageous compensation of the different gas cartridge heights can take place.

A seal means 31, in the form of a flat sealing ring 32 in the illustrated embodiment, is located between the pressure transmission means 40 and the mouth region 20′ of the gas cartridge 20. The pressure transmission means 40 comprises a cutout 43 which is arranged centrally in the pressure transmission means 40. An opening means 61, which comprises a rod-like element 62, extends through the cutout 43 in the pressure transmission means 40. In this case, different cross-sectional areas are conceivable for the rod-like element 62 and the cutout 43, for example circular cross sections. The opening means 61, in particular the rod-like element 62, is able to be guided through a passage opening in the sealing ring 32. When commencing the carbonation, the rod-like element 62 is guided downward parallel to the central axis 200 of the gas cartridge 20 and, as a result, opens the closure means 27 of the gas cartridge 20.

In the illustration shown in FIG. 1, the receiving apparatus 10 and in particular the opening means 61 is shown in a starting position. In this case, the starting position refers to a state in which the gas cartridge 20 has already been introduced into the receiving apparatus 10 but carbonation is not yet carried out (that is to say for example a state prior to carbonation beginning). The opening means 61, in particular the rod-like element 62, has preferably already been guided up to a closure means 27 of the gas cartridge 20 in this starting position. In particular, the position of the opening means 61 in the starting position is dependent on the height of the gas cartridge 20, wherein the opening means 61 is for example arranged in such a way that the opening means 61 rests on the gas cartridge 20 or on the closure means 27 of the gas cartridge 20. In the present case, this is achieved with the aid of the spring device 67 and with the aid of the pressure transmission means 40. Here, the opening means 61 is guided in the starting position in the direction of the gas cartridge 20 by the downwardly acting force exerted on the pressure transmission means 40 with the aid of the spring device 67. For this purpose, the opening means 61 comprises a carrying-along means 69, for example a projection which runs partially or completely in encircling fashion around the rod-like element 62. In the starting position, the pressure transmission means 40 is already pushed in the direction of the gas cartridge 20 (that is to say downward in FIG. 1) by the spring device 67. Here, it is possible for the carrying-along means 69 to engage into the pressure transmission means 40, such that the opening means 61 is also pushed in the direction of the gas cartridge 20 and is already positioned close to the gas cartridge 20 in the starting position.

A further seal means 50, in particular a further sealing ring 51, is arranged between an inner wall 12 of the guide element 11 and the pressure transmission means 40. The inner wall 12 of the guide element 11 is in particular a wall forming the cutout 11′ in the guide element 11. The further seal means 50 is intended to seal the transition between the inner wall 12 of the guide element 11 and the pressure transmission means 40. During the carbonation, the further seal means 50 thus also seals the pressure chamber 30 (and thus also the gas connection 100 at this point) toward the outside. Furthermore, a yet further seal means 55, in particular in the form of a sealing ring 56, is arranged in an upper region of the guide element 11, in particular in a guide channel 57 of the guide element 11, in which the opening means 61 is partially arranged. The yet further seal means 55 is arranged between the guide element 11 and the opening means 61 and thus seals the transition between the guide element 11 and the opening means 61 toward the outside during the carbonation. In particular, during the carbonation, the yet further seal means 55 also seals the pressure chamber 30 (and thus also the gas connection 100 at this point) toward the outside.

A gas channel 42 is formed between the rod-like element 62 and the sealing ring 32 and between the rod-like element 62 and the pressure transmission means 40. When the gas cartridge 20 is opened, that is to say in particular during a carbonation operation, the gas channel 42 connects the interior space 21 of the gas cartridge 20 to the pressure chamber 30 of the receiving apparatus 10. The pressure chamber 30 is partially or completely formed between the pressure transmission element 40 and the guide element 11. The gas channel 42 and the pressure chamber 30 are in particular part of a gas connection 100 which is formed between the interior space 21 of the gas cartridge 20 and the interior space 3 of the bottle 2 during the carbonation and via which gas 28 passes from the interior space 21 of the gas cartridge 20 to the interior space 3 of the bottle 2. Gas 28 from the gas cartridge 20 can thus pass via the gas channel 42 into the pressure chamber 30, as a result of which an overpressure can be generated in the pressure chamber 30. This overpressure in the pressure chamber 30 presses the pressure transmission means 40 downward, that is to say in the direction of the gas cartridge 20. In this way, the pressure transmission means 40 presses the seal means 31, that is to say in particular the sealing ring 32, onto the mouth region 20′ of the gas cartridge 20. Here, the transitions between the gas cartridge 20, the seal means 31 and the pressure transmission means 40 are sealed toward the outside. By way of the pressure chamber 30, automatic pneumatic sealing of the gas connection 100, in particular of the gas channel 42, toward the outside is thus effected when the gas cartridge 20 is opened during the carbonation. At the same time, due to the overpressure which is built up in the pressure chamber 30 during the carbonation and which presses the pressure transmission means 40 in the direction of the gas cartridge 20, the gas cartridge 20 is advantageously and securely clamped and fastened in the carbonation machine 1. In particular, the gas cartridge 20 is clamped between the pressure transmission means 40 and/or the seal means 31 on its upper side 22 and a counterpart element 25, for example a bottom region 26 of the receiving apparatus 10 or of the carbonation machine 1, on its lower side 23. In this way, both pneumatic and automatic sealing of the gas connection 100 toward the outside and secure and stable fastening of the gas cartridge 20 in the receiving apparatus 10, in particular during the carbonation, is particularly advantageously effected by way of the pressure chamber 30. In this case, it is particularly advantageously possible for gas cartridges 20 with different dimensions and tolerances to be fastened with the aid of the receiving apparatus 10. It is also possible for both gas cartridges 20 with a thread and gas cartridges 20 without a thread to be used, wherein the potentially present thread of a gas cartridge 20 does not have to be used to fasten and secure the gas cartridge 20 to the receiving apparatus 10. According to the invention, it is thus particularly advantageously possible to dispense with awkward screwing in of the gas cartridges 20 for fastening the gas cartridges 20 to a carbonation machine 1.

The carbonation machine 1 further comprises an actuating device 60. With the aid of the actuating device 60, the opening means 61, in particular the rod-like element 62, can be moved outward in order to open the closure means 27 of the gas cartridge 20 and commence the carbonation. In the embodiment illustrated, the actuating device 60 comprises a lever device 63. The lever device 63 can for example be actuated directly by a user or be connected to a button, in particular a pushbutton, wherein the lever device 63 is moved by the movement of the button upon actuation of the button by the user. The arrow labeled with the reference designation 128 indicates the gas flow 128 of the gas 28 from the gas cartridge 20 in the direction of the bottle 2 during the carbonation, that is to say with the closure means 27 open.

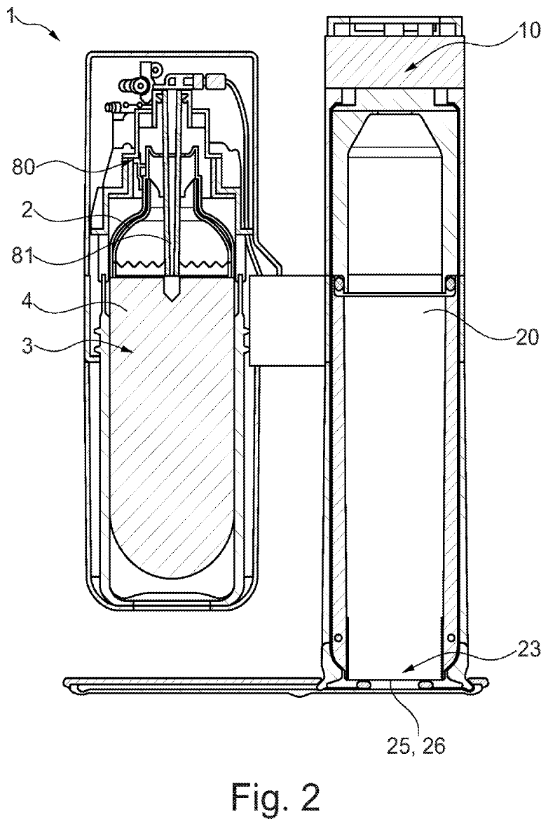

FIG. 2 shows a schematic illustration of a carbonation machine 1 according to one exemplary embodiment of the present invention. A gas cartridge 20 is arranged in the carbonation machine 1 and provides a gas 28 for carbonation of the liquid 4 located in the interior space 3 of the bottle 2. The gas cartridge 20 is fastened to the carbonation machine 1 for example with the aid of a receiving apparatus 10 according to the embodiment shown in FIG. 1. The upper region of the receiving apparatus 10 is not illustrated in detail in FIG. 2. The bottle 2 is fastened to the carbonation machine 1 with the aid of a further receiving apparatus 80. Both the bottle 2 and the gas cartridge 20 are able to be separated from the carbonation machine 1 and in particular removed from the carbonation machine 1. A gas feed means 81, which forms a part of the gas connection 100 between the bottle 2 and the interior space 21 of the gas cartridge 20 during the carbonation, projects into the interior space 3 of the bottle 2. The gas 28 can pass via the gas feed means 81 into the bottle 2, such that the liquid 4 can be carbonated. It is conceivable for the carbonation to be able to be commenced by the actuation of an actuating device 60 by a user.

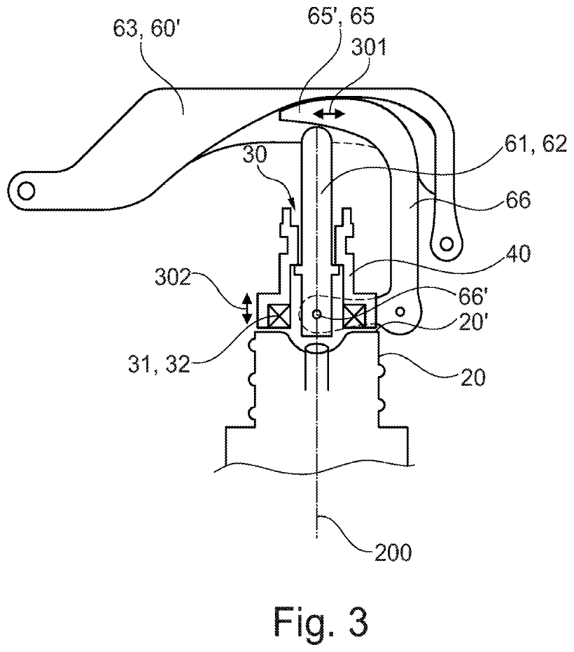

FIG. 3 shows a schematic illustration of a receiving apparatus 10 for receiving a gas cartridge 20 according to one exemplary embodiment of the present invention. The receiving apparatus 10 is part of a carbonation machine 1 or able to be connected to a carbonation machine 1. In the illustration shown, a gas cartridge 20 is received with the aid of the receiving apparatus 10. The gas cartridge 20 is a pressure-stable cartridge, in the interior space 21 of which a gas 28, in particular CO₂, is contained at high pressure. The gas cartridge provides the gas 28 for carbonation of a liquid 4 located in an interior space 3 of a bottle 2. FIG. 3 shows a height compensation means 65′ for compensation of different heights of gas cartridges 20, wherein the height compensation means 65′ comprises a wedge-like element 65. The region around the pressure chamber 30 of the receiving apparatus 10 is not shown in full in the illustration in FIG. 3, but may for example be embodied according to the embodiment shown in FIG. 1.

The wedge-like element 65 is arranged between the opening means 61 and the actuating means 60′, in particular the lever device 63. With the aid of the wedge-like element 65, advantageous height compensation can be effected in the receiving apparatus 10 and/or actuating apparatus for different gas cartridges 20 with in particular different heights. For this purpose, the opening means 61 is connected to a lever system 66 by way of a connection 66′. The lever system 66 is connected to the wedge-like element 65 or the wedge-like element 65 is formed as a constituent part of the lever system 66. The wedge-like element 65 is thus connected to the opening means 61, in particular the rod-like element 62, with the aid of the lever system 66.

By way of the lever system 66, the opening means 61 carries along the wedge-like element 65 in such a way that an insertion depth of the wedge-like element 65 (in a direction perpendicular to the central axis 200 of the gas cartridge 20) between the opening means 61 and the lever device 63 is dependent on the position of the opening means 61 (parallel to the central axis 200 of the gas cartridge 20) in its starting position. The lever system 66 is accordingly configured in such a way that an axial movement 302 of the opening means 61 and/or pressure transmission means 40 parallel to a central axis 200 of the gas cartridge 20 is converted into a lateral movement 301 of the wedge-like element 65 perpendicularly with respect to the central axis 200 of the gas cartridge 20. By way of this lateral movement 301, the insertion depth of the wedge-like element 65 between the opening means 61 and the lever device 63 is changed. When the gas cartridge 20 is being inserted, the wedge-like element 65 is in particular moved between the opening means 61 and the lever device 63 by way of the lever system 66.

The wedge-like element 65 thus makes it possible for mechanical contact between the opening means 61 and the lever device 63 to already be formed in each case in the starting position of the opening means 61 for gas cartridges 20 with different gas cartridge heights, since the insertion depth of the wedge-like element 65 between the opening means 61 and the lever device 63 is dependent on the position of the opening means 61 in the starting position. The wedge-like element 65 is thus updated depending on the position of the opening means 61 in the starting position (with the gas cartridge 20 inserted). The pressure point or actuating point of the actuating device (for example of a pushbutton or a lever device) is thus the same or at least very similar for the user in each case for different gas cartridges 20 with different heights. By way of example, a pushbutton or a lever device 63 triggers at the same actuating point for different gas cartridges 20 with different heights, since the wedge-like element 65 compensates for the height differences. With the aid of the wedge-like element 65, it is thus possible for particularly advantageous height compensation to be achieved for different gas cartridge heights, which allows the carbonation machine 1 to be used in a user-friendly manner with a multiplicity of differently designed gas cartridges 20.

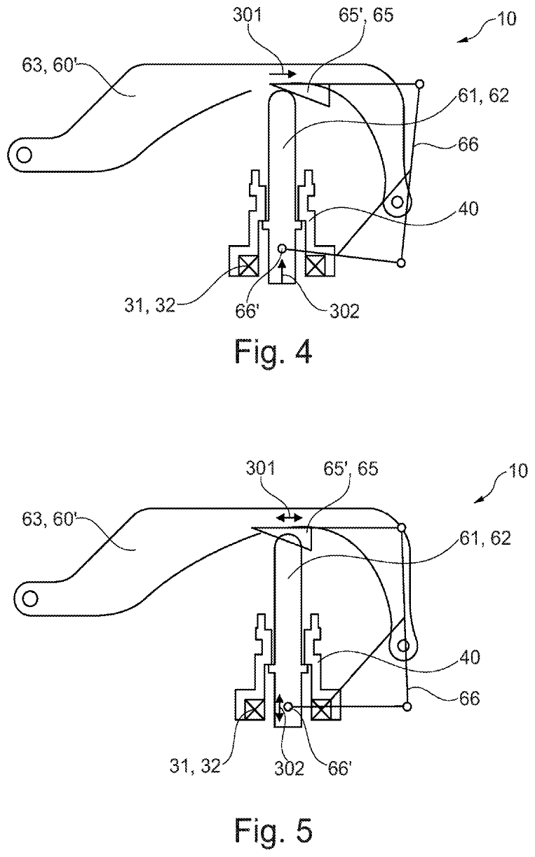

FIG. 4 shows a schematic illustration of a part of a receiving apparatus 10 for receiving a gas cartridge 20 according to one exemplary embodiment of the present invention. The region around the pressure chamber 30 of the receiving apparatus 10 is not shown in full in the illustration in FIG. 4, but may for example be embodied according to the embodiment shown in FIG. 1. FIG. 4 shows a height compensation means 65′ for compensation of different heights of gas cartridges 20, wherein the height compensation means 65′ is in a position that it occupies when a gas cartridge 20 with a comparatively large gas cartridge height is introduced. The opening means 61 and the pressure transmission means 40 are positioned relatively far up in their starting position due to the comparatively large height of the gas cartridge 20, that is to say are displaced relatively far toward the top along their capability for axial movement 302. By way of the lever system 66, the wedge-like element 65 is therefore guided along its lateral movement 301 comparatively far out of the region between the opening means 61 and the lever device 63, that is to say has only a low insertion depth between the opening means 61 and the lever device 63. However, as a result of the fact that the opening means 61 is positioned comparatively far up due to the large height of the gas cartridge 20, mechanical contact between the opening means 61 and the lever device 63 is still formed in the starting position shown by way of the wedge-like element 65. Upon actuation of the actuating device by a user, the lever device 63 thus does not need to first be guided downward until it reaches the opening means 61, but rather there is a well-defined pressure point.

FIG. 5 shows a schematic illustration of a part of a receiving apparatus 10 for receiving a gas cartridge 20 according to the exemplary embodiment of the present invention shown in FIG. 4, wherein the height compensation means 65′ is in a position that it occupies when a gas cartridge 20 with a lower gas cartridge height than in FIG. 4 is introduced. The region around the pressure chamber 30 of the receiving apparatus 10 is not shown in full in the illustration in FIG. 5. The opening means 61 and the pressure transmission means 40 are positioned slightly further down in their starting position due to the lower height of the gas cartridge 20 compared with that in FIG. 4, that is to say are displaced downward along their axial movement 302 in comparison with FIG. 4. By way of the lever system 66, the wedge-like element 65 is therefore guided along its lateral movement 301 further into the region between the opening means 61 and the lever device 63, that is to say has a greater insertion depth between the opening means 61 and the lever device 63. As a result of the fact that the wedge-like element 65 is updated by way of the lever system 66 in this way, mechanical contact between the opening means 61 and the lever device 63 is also formed in this case in the starting position by way of the wedge-like element 65. The pressure point of the actuating device therefore remains the same for the user.

### LIST OF REFERENCE DESIGNATIONS

1 Carbonation machine
2 Bottle
3 Interior space of the bottle
4 Liquid
10 Receiving apparatus
11 Guide element
11′ Cutout in the guide element 11′
12 Inner wall of the guide element
20 Gas cartridge
20′ Mouth region of the gas cartridge
21 Interior space of the gas cartridge
22 Upper side of the gas cartridge
23 Lower side of the gas cartridge
25 Counterpart element
26 Bottom region of the carbonation machine
28 Gas
30 Pressure chamber
31 Seal means
32 Sealing ring
40 Pressure transmission means
41 Boundary of the pressure chamber
41′ Wall of the pressure chamber
42 Gas channel
43 Cutout in the pressure transmission means
50 Further sealing means
51 Sealing ring
55 Yet further sealing means
56 Sealing ring
57 Guide channel
60 Actuating device
60′ Actuating means
61 Opening means
62 Rod-like element
63 Lever device
65 Wedge-like element
65′ Height compensation means
66 Lever system
66′ Connection between lever system and opening means
67 Spring device
68 Helical spring
80 Further receiving apparatus
81 Gas feed means
100 Gas connection
128 Gas flow during the carbonation
200 Central axis of the gas cartridge
301 Lateral movement of the wedge-like element
302 Axial movement of the pressure transmission means

1)-29) (canceled)

30) A receiving apparatus for receiving a gas cartridge for a carbonation machine, the receiving apparatus comprises a pressure chamber in which an overpressure is generated, wherein with aid of the overpressure generated in the pressure chamber: i) a seal means is configured to be pressed onto the gas cartridge; and/or ii) the gas cartridge is configured to be fastened to the carbonation machine;
wherein the receiving apparatus comprises:
a pressure transmission means configured to press the seal means onto the gas cartridge by way of the overpressure generated in the pressure chamber during a carbonation operation; and
a spring device configured to exert a force on the pressure transmission means.

31) The receiving apparatus as claimed in claim 30, wherein during the carbonation operation, the pressure chamber is connected to an interior space of the gas cartridge and the overpressure is generated in the pressure chamber.

32) The receiving apparatus as claimed in claim 31, wherein the pressure chamber is a part of a gas connection through which gas from the interior space of the gas cartridge is introduced during the carbonation operation into a bottle that is filled with a liquid.

33) The receiving apparatus as claimed in claim 30, wherein the pressure transmission means is movable, and the pressure transmission means forms a part of a boundary and/or wall of the pressure chamber.

34) The receiving apparatus as claimed in claim 30, wherein the seal means is partially or completely arranged between the pressure transmission means and the gas cartridge, or between the pressure transmission means and a mouth region of the gas cartridge.

35) The receiving apparatus as claimed in claim 30, wherein the gas cartridge is configured to be clamped with aid of the pressure transmission means and/or fastened in the receiving apparatus.

36) The receiving apparatus as claimed in claim 30, wherein the gas cartridge comprises an upper side and a lower side, wherein the upper side of the gas cartridge is configured to be clamped between the seal means and/or the pressure transmission means, and the lower side of the gas cartridge is configured to be clamped between a counterpart element or a bottom region of the carbonation machine.

37) The receiving apparatus as claimed in claim 30, wherein the receiving apparatus comprises a guide element, wherein the pressure transmission means is arranged within a cutout in the guide element, the pressure transmission means is movable within the cutout in the guide element parallel to a central axis of the gas cartridge when the gas cartridge is arranged in the receiving apparatus.

38) The receiving apparatus as claimed in claim 37, wherein a further seal means is arranged between an inner wall of the guide element and the pressure transmission means.

39) A carbonation machine comprising the receiving apparatus as claimed in claim 30, wherein the carbonation machine comprises an actuating device for commencing and/or carrying out the carbonation operation by a user.

40) The carbonation machine as claimed in claim 39, wherein the actuating device comprises an opening means for opening the gas cartridge.

41) The carbonation machine as claimed in claim 40, wherein the opening means is configured to be transferred from a starting position to a carbonation position, wherein the opening means is arranged in the carbonation position during the carbonation operation.

42) The carbonation machine as claimed in claim 41, wherein the opening means in the carbonation position opens a closure means of the gas cartridge so that gas escapes from the interior space of the gas cartridge and/or a gas connection is formed between the interior space of the gas cartridge and a bottle.

43) The carbonation machine as claimed in claim 40, wherein the opening means comprises a rod-like element.

44) The carbonation machine claimed in claim 39, wherein the actuating device comprises a lever device and/or a push button, wherein the opening means is transferred from a starting position to a carbonation position upon actuation of the lever device by a user.

45) The carbonation machine as claimed in claim 40, wherein a position of the opening means in its starting position is configured depending on a height of the gas cartridge so that the opening means rests on the gas cartridge or rests on an element connected to the closure means.

46) The carbonation machine as claimed in claim 44, wherein a height compensation means is arranged between the opening means and the lever device, wherein the height compensation means comprises a wedge-like element.

47) The carbonation machine as claimed in claim 46, wherein the opening means is connected to the wedge-like element, wherein the opening means in its starting position carries along the wedge-like element in such a way that an insertion depth of the wedge-like element between the opening means and the actuating means is dependent on the position of the opening means in its starting position.

48) The carbonation machine as claimed in claim 46, wherein the opening means is connected to the wedge-like element with the lever system, wherein the lever system is configured such that an axial movement of the opening means parallel to a central axis of the gas cartridge is converted into a lateral movement of the wedge-like element perpendicularly with respect to the central axis of the gas cartridge.

49) A method for using the carbonation machine as claimed in claim 39, wherein the method comprises:
filling a bottle with a liquid;
fitting the bottle fille with the liquid into the carbonation machine;
carbonating the liquid in the bottle;
wherein during the carbonating, an overpressure is generated in the pressure chamber of the receiving apparatus; and
wherein with aid of the overpressure generated in the pressure chamber: i) a seal means is pressed onto the gas cartridge; and/or ii) the gas cartridge is fastened to the carbonation machine.
